(19) United States
(12) Patent Application Publication
(10) Pub. No.: US 2008/0050433 A1
(43) Pub. Date: Feb. 28, 2008

(54) Water-Soluble Films for Releasing Active Substances

(76) Inventors: Michael Roreger, Neuwied (DE); Qian-Yi Li, Pullheim (DE); Malgorzata Kloczko, Neustadt/Wied (DE); Iris Schnitzler, Bonn (DE)

Correspondence Address: FROMMER LAWRENCE & HAUG, 745 FIFTH AVENUE- 10TH FL., NEW YORK, NY, 10151, US

(21) Appl. No.: 11/568,681

(22) PCT Filed: Apr. 19, 2005
(86) PCT No.: PCT/EP05/04136

§ 371 Date: Nov. 3, 2006

(30) Foreign Application Priority Data
May 5, 2004 (DE) 10 2004 022 528.1
May 28, 2004 (DE) 10 2004 026 274.8

(51) Int. Cl. A01N 25/00; A01N 43/48; A01N 43/56; A01N 57/20

(52) U.S. Cl. 424/484; 504/206; 504/253; 504/282; 504/358; 514/114; 514/341; 514/407

(57) ABSTRACT

The invention relates to a water-soluble film for releasing active substances, particularly plant protection products and plant growth promoting substances. The water-soluble film can be defined with regard to its dimensions so that the content of the active substance can be exactly pre-dosed in such a defined film section. The release of the active substance or of the active substance combination from the water-soluble film ensues in a controlled manner by the action of water. The soil, standing and flowing water, surfaces of plants and other objects make up the environment.

The invention relates to a film for releasing active substances to its environs. Active substances in question include those having physiological effects, as for example plant protection products, plant treatment products, and pest control products (pesticides, insecticides, bactericides, acaricides, algicides, fungicides, herbicides, molluscicides, nematocides, rodenticides, and viricides), but also plant growth substances, fertilizers, fragrances, repellants, and attractants. In one preferred embodiment this film is water-soluble.

The prior art embraces water-soluble tablets which comprise active substances and are capable of releasing the active substances on contact with liquid water. Additionally there exist liquid-filled pouches which comprise the active substance in liquid or dissolved form. On contact with liquid water, the material constituting the pouch dissolves and admits the contents into its environs. Also known is the direct addition of active substances in liquid or solid form to a water supply for the purpose of releasing them from the resultant dilute solution into their environs.

It is an object of the present invention to provide a product capable of controlled delivery of an active substance to its environs. In such a product the active substance ought to be readily meterable, the risk of contamination ought to be avoided, and the product ought to be easily meterable, and meterable individually for the user, and to be safe to handle. The risk of overdosing or underdosing ought to be minimized. Finally, the product ought to deliver the active substance completely in the course of its application by exposure to water (i.e., to release it quantitatively) and therefore to be soluble, preferably without residue, in water.

This object is achieved by means of a film which comprises a water-soluble matrix material and at least one active substance. The thickness of the film is between 20 and 1600 μm, preferably between 50 and 500 μm. In one preferred embodiment, however, the film is defined not merely in terms of its thickness but also, instead, in terms of its length and its width, so that the amount of the active substance in a defined film section of this kind can be premetered with precision even during the production operation. Actual metering by the user can then be performed in accordance with the size of a film section of this kind with premetered amount of active substance.

The water-soluble matrix materials include organic and/or inorganic substances which in water are swellable, but preferably completely soluble. The inorganic substances which fall within this definition include, for example, silica, polysilicates, polyphosphoric acid and derivatives thereof, polyboric acids, clay, etc. The organic substances suitable as water-soluble matrix materials include organic polymers such as polyvinyl alcohol, wheat protein and derivatives thereof, carbohydrates, starch (from different plant sources), amylose and derivatives thereof, amylopectin and derivatives thereof, cellulose and derivatives thereof, hydrolyzed starch, modified starch, modified starch derivatives, maltodextrins, hydroxypropylmethylcellulose (HPMC), polyvinylpyrrolidone (PVP), chitin, chitosan, polysaccharide gums and derivatives thereof, polyethylene glycol, water-soluble polyacrylates, water-soluble polyesters, hydroxyalkyl starch, polyvinylpyrrolidone-cellulose derivatives, casein, gelatin, solubilized proteins, polyacrylamides, polyamines, styrene-maleic anhydride resins, polyethyleneamine, and xanthan gum. The water-soluble matrix materials used with preference include polyvinyl alcohol, hydroxypropylcellulose, and polyvinylpyrrolidone. The organic and inorganic water-soluble matrix materials can also be used in combinations. The fraction of the water-soluble matrix materials in the active substance film is at least 20% by weight, preferably at least 45% by weight.

Suitable active substances are those which possess a physiological effect. These include, in particular, plant protection products, plant treatment products, pest control products, plant growth substances, fertilizers, fragrances, repellants, and attractants. These are known to the skilled worker. Precise details of the active substances can be found in, for example, “The Pesticide Manual”, 9th Ed., published by The British Crop Protection Council (1991). They include: (E)7-(Z)9-dodecadienyl acetate, (Z)-9-dodecenyl acetate, (Z)11-tetradecen-1-yl acetate, (Z,Z)-3,13-octadecadien-1-yl acetate, 1-methylheptyl ester, 1-methylhexyl ester, 1-naphthylacetic acid, 2,4-D, 3-indolylacetic acid, 4-(3-indolyl), butyric acid, 8-hydroxiquinoline, abamectin, acetamiprid, acetate, aclonifen, alpha-cypermethrin, aluminum salt, aluminum phosphide, amidosulfuron, amitrole, ammonium salt, codling moth granulosis virus, azadirachtin (neem), azocyclotin, azoxystrobin, Bacillus thuringiensis, tree waxes, beflubutamid, benfuracarb, bentazone, benzoic acid, beta-cyfluthrin, bifenox, bitertanol, boscalid, brodifacoum, bromadiolone, bromoxynil, bromuconazole, buprofezin, butoxyethyl ester, butyl ester, calcium salt, calcium carbide, calcium phosphide, captan, carbendazim, carbetamide, carbofuran, carbosulfan, carboxin, carfentrazone, quinoline derivatives, chlorfenvinphos, chloride, chloridazon, chlormequat, chlorphacinon, chlorpropham, chlorpyrifos, chlorthalonil, cinidon-ethyl, clethodim, clodinafop, clomazone, clopyralid, cloquintocet, codlemone, Coniothyrium minitans, cyazofamid, cycloxydim, cyfluthrin, cymoxanil, cyproconazole, cyprodinil, dazomet, deiquat, deltamethrin, desmedipham, dibromide, dicamba, dichlorobenzoic acid methyl ester, dichloride, dichlorprop-p, dichlorvos, diethanolamine salt, diethofencarb, diethyl ester, difenacoum, difenoconazole, diflubenzuron, diflufenican, dikegulac, dimefuron, dimethachlor, dimethenamid-p, dimethoate, dimethomorph, dimethylamine salt, dithianone, diuron, iron(II) sulfate, iron(III) phosphate, iron(III) sulfate, epoxiconazole, esfenvalerate, acetic acid, ethephon, ethofumesate, ethyl ester, famoxadone, fenarimol, fenazaquin, fenbuconazole, fenhexamid, fenoxaprop-p, fenoxycarb, fenpropidin, fenpropimorph, fenpyroximate, fipronil, florasulam, fluazifop-p, fluazinam, fludioxonil, flufenacet, flumioxazin, flupyrsulfuron, fluquinconazole, flurochloridone, fluroxypyr, flurprimidol, flurtamone, flusilazole, flutriafol, folpet, foramsulfuron, fosetyl, fuberidazole, glyphosate, glyphosate-trimesium, guazatin, haloxyfop-r, haloxyfop-p, heptahydrate, hydrochloride, hymexazole, imazalil, imazosulfuron, imidacloprid, indoxacarb, iodosulfuron, ioxynil, iprodione, isopropylamine salt, isoproturon, isoxaben, isoxadifen (safener), isoxaflutole, potash soap, potassium salt, potassium/sodium salt, kieselguhr, kresoxim-methyl, copper chloride complex, copper hydroxide, copper octanoate, copper oxychloride, lambda-cyhalothrin, lecithin, magnesium salt, magnesium phosphide, mancozeb, maneb, mcpa, mecoprop-p, mefenpyr, mesosulfuron, mesotrione, metalaxyl, metalaxyl-m, metaldehyde, metam, metamitron, metazachlor, metconazole, methamidophos, methidathion, methiocarb, methoxyfenozide, methyl ester, methyl ester-Na, metiram, metobromuron, metosulam, metribuzin, metsulfuron, mexyl, mineral oils, monoethanolamine salt, monohydrate, myclobutanil, napropamide, sodium salt, nicosulfuron, octanoic esters, oxydemeton-methyl, paraquat, perfume oil daphne, penconazole, pencycuron, pendimethalin, phenmedipham, pheromones, hydrogen phosphide, phoxim, picoxystrobin, piperonyl butoxide, pirimiphos-methyl, prochloraz, prohexadione, propamocarb, propaquizafop, propargyl (2-propynyl ester), propiconazole, propineb, propoxycarbazone, propyzamide, prosulfocarb, pymetrozine, pyraclostrobin, pyrethrines, pyridate, pyrimethanil, quinmerac, quinoclamine, quinoxyfen, quizalofop-p, rapeseed oil, rimsulfuron, S-metolachlor, summerfruit tortrix moth granulosis virus, sulfur, silthiofam, spinosad, spiroxamine, sulcotrione, sulfaquinoxaline, sulfate, sulfosulfuron, sulfotep, tebuconazole, tebufenozide, tebufenpyrad, teflubenzuron, tefluthrin, tepraloxydim, terbuthylazine, thiabendazole, thiacloprid, thiamethoxam, thifensulfuron, thiodicarb, thiram, tolclofos-methyl, tolylfluanid, triadimenol, triasulfuron, tribenuron, triclopyr, trifloxystrobin, trifluralin, triflusulfuron, trinexapac, triticonazole, var. aizawai, var. kurstaki, var. tenebrionis, warfarin, zinc phosphide, zoxamide. These active substances may be present individually or else in combinations of at least two active substances within the film.

An “active substance” for the purposes of this description also includes biopesticides. These biopesticides are organisms which are employed as natural enemies of pathogens. Corresponding to the group of organisms in question, a distinction is made between mycoinsecticides (fungi which infest and kill caterpillars, aphids, grasshoppers and locusts, etc.), nematode or bacterial insecticides (soil-borne worms with symbiotic bacteria, which infect insects and kill them as a result of the bacteria they carry), bacterial insecticides (e.g., Bacillus thuringiensis, whose active toxin can also be employed genetically directly), mycoherbicides (use of fungi, for weed control, for example), and insect viruses (especially baculoviruses with high specificity against individual insect species or groups).

Particularly preferred active substances are imidacloprid, fipronil, and glyphosate.

The fraction of the active substance in the film may depend on the duration of the planned release, the intended application, and the particular activity of the active substance in question. It is therefore not possible to state any generally valid proportions for the active substance in the film. Ranges between 0.01% and 85% by weight are possible; a preferred quantity range is between 10% and 60% by weight of active substance in the film.

The release of the active substance or active substance combinations from the film takes place controlledly. The release mechanism is primarily dependent on the water-solubility of the active substance in question, the water-solubility of the matrix material in question, the duration of exposure to water, the physical form of the water (liquid, gaseous), and the thickness of the film. The release period can therefore be modified substantially through appropriate selection of the matrix materials and their proportion in the film.

In accordance with the desired release period the matrix material can be selected such that slow decomposition takes place through exposure to gaseous water (atmospheric humidity), which results, accordingly, in delayed release of the active substance. On the other hand, the active substance is released more rapidly on exposure to rain and/or groundwater (i.e., liquid water).

Irrespective of the exposure duration and the form of the water, the release of the active substance can also be retarded by using a matrix material of particularly low water-solubility. In this case the release of the active substance is controlled substantially by diffusion, whereas in the aforementioned cases the active substance is controlled by erosion.

The release of active substance over time can therefore be designed in such a way that it takes place very quickly (in a period of a few seconds); alternatively it may be retarded over minutes, hours, days, months, and years. Responsible for this are—as stated—the water content of the environs and the nature of the film (water-solubility of the matrix material).

The film may also comprise auxiliaries, such as, for example, dyes, antioxidants, film formers, gel formers, surfactants, pressure-sensitive adhesives, tackifier resins, salts, oxides, and pigments.

These auxiliaries may influence mechanical properties among others, so that the film may have at least one of the following properties: flexible, elastic, adhesive, transparent, colored, nonadhesive.

The film for releasing active substances can be employed in the private home and garden sector but also in agriculture and forestry. By environs in the sense of the present description are meant in particular the soil, standing water bodies and flowing watercourses, and surfaces of plants and articles. In the context of practical application, in one alternative the film is employed directly at the site of application in the environs, so that the active substance can be released over a predetermined period through exposure to gaseous or liquid water. Another possibility is to add the film—in particular a film section of defined size and premetered active substance content—to a (limited) water supply, in which the film dissolves rapidly and so allows the active substance to be released in the water supply or, as a result of distribution of this water supply, to the environs.

In one particular embodiment the film may also be covered with—at least one, preferably two—layers free from active substance, which are located on its top and/or bottom face. The absence of an active substance reduces the risk of unintended contamination in the event the film is grasped with the hands. The at least one layer free from active substance is preferably composed of a water-soluble matrix material.

The examples which follow are intended to illustrate the invention, without restricting it to these examples in any way whatsoever. Films (wafers) were manufactured with different concentrations of imidacloprid. The films can be used to control termites. Additionally, examples with other matrix materials and other active substances were manufactured, in order to show the effect achievable therewith on the release of the active substance over time.

The films can be produced by coating, casting or extrusion techniques familiar to the skilled worker, from a solution or melt of the formulating ingredients.

### EXAMPLE 1

| Formula | Solid [%] | Liquid [g] | Batch [g] |
|---|---|---|---|
| Mowiol 8-88, 25% strength | 55.56 | 222.24 | 16.46 |
| solution in water | | | |
| Water | — | — | 17.60 |
| Imidacloprid SC 350; 30.5% | 44.44 | 145.70 | 10.79 |

Mowiol 8-88 is a polyvinyl alcohol; imidacloprid is an insecticide with the name 1-(6-chloro-3-pyridylmethyl)-N-nitroimidazolidin-2-ylideneamine.

The components are mixed and the mixture is coated out using a box-type coating bar to a coat thickness of 400 μm onto the unsiliconized side of a backing film (release liner) of brand PA PE2 AB1 (basis weight: 120 g/m²). Drying at 80° C. for 60 minutes (in a drying cabinet) gives a film having a basis weight of 72 g/m². The concentration of imidacloprid is 32 g/m².

The film dissolves within a few seconds in an excess of water and releases the active substance completely within the same time. The film is especially suitable for producing pourable or sprayable solutions of the insecticide.

### EXAMPLE 2

| Formula | Solid [%] | Liquid [g] | Batch [g] |
|---|---|---|---|
| Mowiol 8-88, 25% strength | 52.36 | 209.44 | 16.00 |
| solution | | | |
| Texapon NSO 100% | 13.09 | 13.09 | 1.00 |
| Water | — | — | 12.50 |
| Imidacloprid SC 350; 30.5% | 34.55 | 113.28 | 8.65 |

Production takes place as under Example 1. Texapon NSO is a surfactant.
Coat thickness: 300 μm, box-type coating bar
Basis weight: 50 g/m²
Release liner: PA PE2 AB1, 120 g/m² unsiliconized side
Drying conditions: 80° C./60 minutes

The dried film contains imidacloprid in a concentration of 17.3 g/m² and dissolves in water within a few seconds.

### EXAMPLE 3

| Formula | Solid [%] | Liquid [g] | Batch [g] |
|---|---|---|---|
| Mowiol 8-88, 25% strength | 30.77 | 123.08 | 16.00 |
| solution | | | |
| Texapon NSO 100% | 7.69 | 7.69 | 1.00 |
| Water | — | — | 7.00 |
| Imidacloprid SC 350; 30.5% | 61.54 | 201.77 | 26.24 |

Production takes place as under Example 1.
Coat thickness: 400 μm, box-type coating bar
Basis weight: 109 g/m²
Release liner: PA PE2 AB1, 120 g/M² unsiliconized side
Drying conditions: 80° C./60 minutes

The dried film contains imidacloprid in a concentration of 67 g/m² and dissolves in water within a few seconds.

### EXAMPLE 4

| Formula | Solid [%] | Liquid [g] | Batch [g] |
|---|---|---|---|
| Mowiol 8-88, 25% strength | 69.44 | 277.76 | 92.59 |
| solution | | | |
| Texapon NSO 100% | 17.36 | 17.36 | 5.79 |
| Water | — | — | 61.73 |
| Imidacloprid SC 350; 30.5% | 13.19 | 43.25 | 14.42 |

Production takes place as under Example 1.
Coat thickness: 300 μm, box-type coating bar
Basis weight: 56 g/m²
Release liner: PA PE2 AB1, 120 g/m² unsiliconized side
Form: 15 cm width, 39 cm length
Drying conditions: 80° C./60 minutes

The films are obtained in the form specified above, cut from the specimen in a format of 15 cm×29 cm.

The dried film contains imidacloprid in a concentration of 7.4 g/m² and is readily water-soluble.

### EXAMPLE 5

| Formula | Solid [%] | Liquid [g] | Batch [g] |
|---|---|---|---|
| Mowiol 8-88, 25% strength | 48.00 | 192.00 | 64.00 |
| solution | | | |
| Texapon NSO 100% | 12.00 | 12.00 | 4.00 |
| Water | — | — | 42.67 |
| Imidacloprid SC 350; 30.5% | 40.00 | 131.15 | 43.72 |

Production takes place as under Example 1.
Coat thickness: 200 μm, box-type coating bar
Basis weight: 46 g/m²
Release liner: PA PE2 AB1, 120 g/m² unsiliconized side
Form: 15 cm width, 39 cm length
Drying conditions: 80° C./60 minutes

The dried film contains imidacloprid in a concentration of 18.4 g/m² and is readily water-soluble.

### EXAMPLE 6

| Formula | Solid [%] | Liquid [g] | Batch [g] |
|---|---|---|---|
| Mowiol 8-88, 25% strength | 32.00 | 128.00 | 42.67 |
| solution | | | |
| Texapon NSO 100% | 8.00 | 8.00 | 2.67 |
| Water | — | — | 28.45 |
| Imidacloprid SC 350; 30.5% | 60.00 | 196.72 | 98.36 |

Production takes place as under Example 1.
Coat thickness: 300 μm, box-type coating bar
Basis weight: 80 g/m²
Release liner: PA PE2 AB1, 120 g/m² unsiliconized side
Form: 15 cm width, 39 cm length
Drying conditions: 80° C./60 minutes

The dried film contains imidacloprid in a concentration of 48 g/m² and is readily water-soluble.

### EXAMPLE 7

| Formula | Solid [%] | Liquid [g] | Batch [g] |
|---|---|---|---|
| Mowiol 8-88, 25% strength | 52.36 | 209.44 | 16.00 |
| solution | | | |
| Texapon NSO 100% | 13.09 | 13.09 | 1.00 |
| Water | — | — | 12.50 |
| Fipronil | 34.55 | 34.55 | 2.64 |

Production takes place as under Example 1. Fipronil is an insecticide with the name (±)-5-amino-1-(2,6-dichloro-α,α,α-trifluoro-p-tolyl)-4-trifluoromethyl-sulfinylpyrazole-3-carbonitrile.
Coat thickness: 300 μm, box-type coating bar
Basis weight: 50 g/m²
Release liner: PA PE2 AB1, 120 g/m² unsiliconized side
Drying conditions: 80° C./60 minutes

The dried film contains fipronil in a concentration of 17.3 g/m² and releases the active substance completely in an excess of water.

### EXAMPLE 8

| Formula | Solid [%] | Liquid [g] |
|---|---|---|
| Hydroxypropylmethylcellulose | 77.0 | 400.0 |
| 12.5% strength solution in water | | |
| (Metholose 60 SH 50) | | |
| Propylene glycol | 3.0 | 1.95 |
| Glyphosate (= N- | 20.0 | 12.99 |
| phosphonomethyl)glycine) | | |

Propylene glycol and glyphosate are incorporated homogeneously, with stirring, into the HPMC solution, which has been heated to 60° C. The hot solution is applied by means of a roll applicator to a polyester film, 50 μm, with a coat weight of approximately 180 g/m², and this is followed by drying in a drying tunnel at 60° C.

The resulting film, with a basis weight of approximately 32.5 g/m² and an active substance content of 20%, dissolves within 15 minutes in an excess of water and in the same period completely releases the herbicide.

### EXAMPLE 9

| Formula | Solid [%] | Liquid [g] |
|---|---|---|
| Gelatin | 50.0 | 50.0 |
| Polyvinylpyrrolidone | 10.0 | 10.0 |
| (Kollidon 90) | | |
| Sodium carboxymethylstarch | 5.0 | 5.0 |
| Glycerol | 10.0 | 10.0 |
| Neem seed extract | 25.0 | 100.0 |
| (25% strength in water) | | |
| Water | — | 125.0 |

Water and glycerol are mixed and heated to 80° C. In the heated solution there are incorporated in succession and with stirring polyvinylpyrrolidone, gelatin, sodium carboxymethylstarch, and, lastly, the neem seed extract, until the solution is clear.

The highly viscous, hot solution is coated by means of a doctor-blade applicator onto the siliconized side of a single-sided siliconized polyester film, 100 μm, with a coat weight of approximately 450 g/m², and then dried in a drying tunnel at 60° C.

The resulting film, with a basis weight of approximately 150 g/m², contains 25% dry neem seed extract with the principal active substance azadirachtin. In an excess of water the film initially swells. As the film successively dissolves over a period of 48 hours, the insecticidal extract is released in retarded but uniform fashion.

### EXAMPLE 10

| Formula | Solid [%] | Liquid [g] |
|---|---|---|
| Sodium carboxymethylcellulose | 45.0 | 225.0 |
| (Walocel 10000) | | |
| Ethylene-vinyl acetate | 20.0 | 100.0 |
| (Evatane 40-55) | | |
| Neutral oil | 10.0 | 50.0 |
| (Miglyol 812) | | |
| Fipronil | 25.0 | 125.0 |

Ethylene-vinyl acetate is melted in a heatable vessel at 130° C. The viscosity of the melt is reduced by adding the neutral oil Miglyol 812. Sodium carboxymethylcellulose and fipronil are dispersed in the melt with stirring.

The melt is coated by means of slot-die application to the siliconized side of a single-sidedly siliconized polyester film, 100 μm, with a coat weight of approximately 250 g/m²¹ and then cooled to room temperature by means of chill rolls.

The resulting film swells slowly in the presence of water. With successive erosion and decomposition of the film over a period of 7 days, the insecticide is released slowly and uniformly.

### EXAMPLE 11

| Formula | Solid [%] | Liquid [g] |
|---|---|---|
| Sodium carboxymethylcellulose | 24.0 | 96.0 |
| (Walocel 10000) | | |
| Ethylene-vinyl acetate | 40.0 | 160.0 |
| (Evatane 40-55) | | |
| Neutral oil | 20.0 | 80.0 |
| (Miglyol 812) | | |
| Imidacloprid | 16.0 | 64.0 |

Ethylene-vinyl acetate is melted in a heatable vessel at 130° C. The viscosity of the melt is reduced by adding the neutral oil Miglyol 812. Sodium carboxymethylcellulose and imidacloprid are dispersed in the melt with stirring.

The melt is coated by means of slot-die application to the siliconized side of a single-sidedly siliconized polyester film, 100 μm, with a coat weight of approximately 125 g/m², and then cooled to room temperature by means of chill rolls.

The resulting film swells very slowly in the presence of water. With successive erosion and decomposition of the film over a period of 4 weeks, the insecticide is released slowly and uniformly.

1. An active substance film comprising a water-soluble matrix material and an active substance, characterized in that the active substance is released controlled from the film to its environs by exposure to water.

2. The active substance film of claim 1, characterized in that the water-soluble matrix material is an organic and/or inorganic material which is swellable in water, but preferably completely water-soluble.

3. The active substance film of claim 1, characterized in that the active substance is selected from the group of plant treatment products, plant protection products, growth substances, pest control products, fertilizers, and fragrances.

4. The active substance film of claim 1, characterized in that the film has a thickness between 20 and 1600 μm, preferably a thickness between 50 and 500 μm.

5. The active substance film of claim 1, characterized in that the film is water-soluble.

6. The active substance film of claim 1, characterized in that the active substance is imidacloprid.

7. The active substance film of claim 1, characterized in that the active substance is fipronil.

8. The active substance film of claim 1, characterized in that the active substance is glyphosate.

9. The active substance film of claim 1, characterized in that it is nonadhesive.

10. The active substance film of claim 1, characterized in that it is adhesive.

11. The use of an active substance film of claim 1, for producing a pourable or sprayable active substance solution, particularly an aqueous solution, for delivering the active substance into the soil, into standing water, into flowing water, to surfaces of plants, and to surfaces of articles.
